(19) United States
(12) Patent Application Publication
(10) Pub. No.: US 2013/0071647 A1
(43) Pub. Date: Mar. 21, 2013

(54) SPRAY POWDER FOR CERMET-COATING OF DOCTOR BLADES

(71) Applicants: Wolfgang Peter Mayr, Wien (AT); Antje Berendes, Bergatreute (DE); Hubert Bischof, Murzzuschlag (AT); Alexander Etschmaier, Nueberg (AT); Norbert Gamsjäger, Bad Fischau (AT)

(72) Inventors: Wolfgang Peter Mayr, Wien (AT); Antje Berendes, Bergatreute (DE); Hubert Bischof, Murzzuschlag (AT); Alexander Etschmaier, Nueberg (AT); Norbert Gamsjäger, Bad Fischau (AT)

(21) Appl. No.: 13/425,805

(22) Filed: Mar. 21, 2012

Related U.S. Application Data
(63) Continuation of application No. PCT/EP2010/061252, filed on Aug. 3, 2010.

(30) Foreign Application Priority Data
Sep. 23, 2009 (DE) 10 2009 029 697.2

(51) Int. Cl. C09D 1/00

(52) U.S. Cl. CPC C09D 1/00
USPC 428/325; 75/252

(57) ABSTRACT

The invention relates to a spray powder for the production of a Cermet coating on a doctor blade surface, wherein the spray powder includes a mixture of a metal powder and a hard material powder, wherein at least 90 percent of the granules of the metal powder are smaller than 63 μm, and preferably smaller than 48 μm, and at least 90 percent of the granules of the hard material powder are smaller than 2 μm.

### CROSS REFERENCE TO RELATED APPLICATIONS

This is a continuation of PCT application No. PCT/EP2010/061252, entitled “SPRAY POWDER FOR THE CERMET COATING OF DOCTOR BLADES”, filed Aug. 3, 2010, which is incorporated herein by reference.

### BACKGROUND OF THE INVENTION

1. Field of the Invention

The invention relates to a doctor blade for machines for paper production and relates in particular to the coating of doctor blades to improve the doctor blade surface.

2. Description of the Related Art

As a rule, the fibrous web, the so-called base-paper web, produced in the paper manufacturing process does not yet possess the surface properties required for specific paper qualities which are to be produced and must therefore be processed accordingly.

For smoothing of the web surface a pasty coating layer consisting of pigments, binding agents and additives is generally applied to said surface. Coating of the paper web can occur in a separate operation, but is however normally integrated into the paper manufacturing process through integration of a coater into the paper machine. Smooth paper surfaces are achieved with the blade coating method, whereby an excess of coating medium is initially applied onto the paper and is then doctored off with a doctor blade. Due to the pressure exerted on the coating medium by the doctor blade which is referred to as a coating blade the indentations on the paper surface are filled with coating medium, thereby achieving a uniform surface on the coated paper.

On certain papers, for example hygienic papers the surface of the fibrous web is structured by directing the web over a doctor, which is referred to as creping doctor blade.

Moreover, doctor blades are used for scraping of rolls, in order to keep their surfaces clear of paper residue and other contaminants, and to thereby safeguard against deterioration in the paper quality during the manufacturing process.

Based on the high pressure which is exerted by the doctor blade on the paper web, whereby as a rule the contact pressure is 150 N/m (contact pressure relative to the length of the doctor blade) or higher, high demands are put upon the wear resistance of the doctor blade. Doctor blades used in surface treatment of the paper web are therefore often manufactured from high-tensile steel.

To improve the wear resistance, namely to reduce the rate of wear of the doctor blade it is known to provide the doctor blades in the regions in which they are intended to rest on the paper web or respectively make contact with the coating material with a coating which possesses a higher wear resistance than the base material of the doctor blade. Cermet-coatings have proven to be especially wear resistant. The term “Cermet” relates to a composite material in which hard materials are embedded in a metallic matrix. Hard materials used in Cermets are ceramics as well as non-ceramic materials.

Cermets are normally applied onto a doctor blade base body in thermal coating processes, for example plasma spraying, high-velocity flame spraying (acronym HVOF derived from the English designation High Velocity Oxygen Fuel Spraying) or high-velocity air-fuel-flame spraying (acronym HVAF, derived from the English designation High Velocity Air Fuel Spraying). In these processes a spray powder material is supplied to the combustor chamber or the expansion nozzle of the coating device. In order to produce Cermets, the supplied spray powder normally consists of a heterogeneous mixture of granules to form the metallic matrix (referred to as matrix powder in the following description) and hard material granules (referred to as hard material powder in the following description) for embedding into the metallic matrix. A heterogeneous mixture in this context is to be understood to be a mixture of granular materials. In order to form a viscous matrix, hard alloys on iron-, nickel or cobalt basis are preferably used for the matrix powder. In addition to the originally preferred characteristic hard phases such as carbides, nitrides, borides or silicides, heterogeneous hard materials, for example tungsten carbide or chromium carbide is increasingly used.

Spray powder is currently used whereby the granules of the matrix powder typically feature a size between approximately 10 and 63 μm. As a rule, the granule sizes of the hard material powder are determined by the respective hard material. With agglomerated and sintered powders the granule size distribution of the hard material for achieving hard Cermet-surfaces is generally in a range between approximately 1 and 2.5 μm when using tungsten carbide as hard material, and when using chromium carbide above approximately 3 μm. Cermet-coatings produced with appropriate granule sizes possess a very high wear resistance against abrasive, adhesive and erosive demands.

A disadvantage of spray powders with respective granule size distribution is however the roughness of the sprayed coated surfaces resulting from the used granule sizes and in particular the granule sizes of the hard materials, which then requires expensive finishing. Moreover it has been shown that there is a correlation between the granule size of the hard materials and the spray powder consumption, whereby overspray, namely a portion of the spray powder which does not become part of the coating, increases with the granule size.

Based on these facts it is therefore desirable to cite, and what is needed in the art is, a spray powder to produce Cermet-coatings in a thermal coating process, which permits the production of Cermet-coatings with improved characteristics.

### SUMMARY OF THE INVENTION

According to one design form a spray powder to produce a Cermet coating on a doctor blade surface is hereby cited (and the present invention provides such a spray powder), wherein the spray powder includes a heterogeneous mixture consisting of one metallic powder and one hard material powder and wherein at least 90% of the granules of the metallic powder have sizes of less than 63 μm and preferably less than 48 μm, and at least 90% of the granules of the hard material powder feature sizes of less than 2 μm.

Utilization of a metal powder having the cited granule size distribution allows for the formation of a coating having low porosity in which the hard materials are evenly distributed. Hard material granules with a granule size distribution in which 90% of the granules have a size of less than 2 μm, possess good dispersion properties in a metallic matrix and are therefore finely distributed in the Cermet-coating produced with the spray powder. The uniform fine distribution of the hard material granules in the metallic matrix allows the formation of a coating surface with little roughness which requires little finishing. Due to the favorable dispersion properties and the fine and uniform distribution of the hard material granules in the metal matrix of the coating resulting therefrom, the portion of the hard materials in the coating volume is subject to only low local fluctuations. The load exerted upon the coating surface is hereby absorbed uniformly by the hard material granules, thereby improving the wear resistance of the coating. Moreover, the material losses incurred during the application of the Cermet-coating with a spray powder according to the cited design form are reduced since the overspray reduces with decreasing granule sizes of the hard material.

The homogeneity of the incorporation of hard material granules into the metal matrix can be improved through a narrow granule size distribution. According to one design form a metal powder is used whereby at least 90% of the granules feature sizes of larger than 10 μm and preferably larger than 18 μm. In this context it is pointed out that terms used in this description and in the claims in listing of characteristics, such as “comprise”, “feature/exhibit”, “include”, “contain” and “with” as well as grammatical variations thereof are generally not to be viewed as a conclusive listing of characteristics such as process steps, devices, regions, sizes and the like and are in no way to exclude the presence of other or additional characteristics of groupings of other or additional characteristics.

To form a hard material portion which is distributed as homogeneously as possible in the coating, hard material powders with a narrow granule size distribution are used in accordance with an additional design form, wherein design forms where 90% of the granules of the hard material powder feature sizes of larger than 15 nm and preferably larger than 0.5 μm are preferred.

In order to keep the likelihood of eliminating hard material granules from the metal matrix of a Cermet-coating as low as possible, a matrix material is selected which is as viscous as possible. According to one design variation, the metal powder comprises for this at least 80% material which is selected from a group which contains iron, cobalt, copper, nickel, chromium and their alloys, as well as mixtures thereof. In one preferred design form the metal powder utilized in the spray powder contains at least up to 80% material, selected from a group which includes nickel (Ni), nickel-chromium alloys (NiCr), cobalt-chromium alloys (CoCr), and alloys of the system nickel-cobalt-chromium (NiCoCr). Nickel as well as the referred to alloys exhibits flow properties during application in a thermal coating process which facilitates composition of homogeneous coatings with low porosity.

According to an additional design form, the hard material powder used in the spray powder contains at least up to 80% of material which is selected from a group which includes carbides, nitrides, carbonitrides, borides and ceramic metal oxides. In an additional design form the hard material powder includes carbides selected from a group which comprises carbides and mixed carbides of the elements: tungsten (W), chromium (Cr), vanadium (V), tantalum (Ta), titanium (Ti), molybdenum (Mo), niobium (Nb) and boron (B). In an additional design form 90% of the carbide granules contained in the hard material powder feature sizes larger than 0.4 μm and preferably larger than 0.6 μm and at least 90% of the carbide granules features sizes of smaller than 1.0 μm and preferably smaller than 0.8 μm. An accordingly narrow granule size distribution of the carbides facilitates a uniform dispersion of the hard material granules in the metal matrix of the Cermet-coating and results in a uniform distribution of the hard material portion within the Cermet-coating and therefore also on its surface.

In accordance with an additional advantageous design form the hard material powder used in the spray powder comprises ceramic metal oxides which are selected from a group which includes ceramic metal oxides of the elements: chromium (Cr), aluminum (Al), titanium (Ti), yttrium (Y) and zirconium (Zr), as well as mixtures thereof. In an additional design form at least 90% of the metal oxide granules of the hard material powder feature sizes larger than 15 nm and preferably larger than 0.5 μm, and at least 90% of the metal oxide granules feature sizes smaller than 2.0 μm and preferably smaller than 0.8 μm.

An additional design form relates to a doctor blade with a Cermet-coating which is produced in a thermal coating process with the use of a spray powder described above, whereby the thickness of the Cermet-coating is at least 0.15 μm and 300 μm maximum and preferably at least 1.0 μm and 200 μm maximum.

Additional characteristics of the invention result from the following description of design examples, together with the claims and the drawings. The individual characteristics can be realized according to the invention in one design form alone, or in several.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is an example of a coated doctor blade shown in a schematic cross section; and

FIG. 2 is a schematic view to illustrate the thermal coating of doctor blades.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

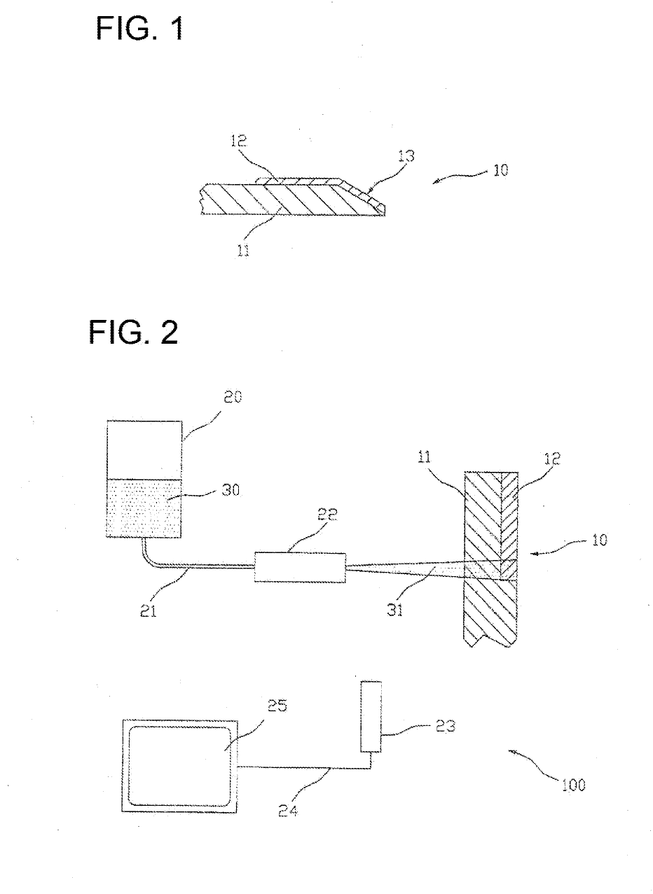

The schematic view of FIG. 1 shows a cross section through the front region of a doctor blade 10 provided with a coating 12. Coating 12 occupies at least that region of doctor blade 10 which comes into contact with the fibrous web or respectively with the coating material applied thereto. Doctor blade 10 features a base body 11, which may for example be made of spring steel and onto which the wear resistant Cermet-coating 12 is applied. On the front region of the doctor blade is a bevel 13, which is generally known as blade edge. As a rule, Cermet-coating 12 covers base body 11, as illustrated in FIG. 1, also in the region of blade edge 13. In order to produce the roughness of the Cermet-coating surface necessary for the respective production step in which doctor blade 10 is utilized, it is ground as a rule after application of the coating. In addition to smoothing the coating surface, the sharp edges of coating 12 can also be removed through grinding in order to thereby avoid a possible impairment of the paper web surface.

FIG. 2 illustrates an arrangement 100 for thermal coating of a doctor blade. Unit 100 comprises a container 20 for supply of spray powder 30 which is transported through a feed device 21 to spray burner 22 which is often shaped like a pistol. A very hot gas or plasma is produced in spray burner 22 which emerges through an expansion nozzle from spray burner 22. The spray medium fed to the combustor or to the nozzle is carried along by the gas flow, whereby the metal powder portion of the spray powder is melted in the hot gas flow in order to be thrown—together with the particles of the hard material powder—onto the surface of doctor blade body 11 which is to be coated. Doctor blade base body 11 is hereby not fused, but only thermally stressed to a lesser extent. In order to monitor the coating parameters, device 100 is equipped with a flame monitor 23 whose measured values are transmitted via a signal—or respectively data connection 24—to an information display unit 25, where they can be made visible. Alternatively, the measuring signals received via flame monitor 23 can also be used to control the spray burner and the feed of spray powder 30. Particle jet 31 carried along by the hot gas flow is preferably moved over the surface of doctor blade base body 11 which is to be coated, so that the coating is gradually built up in several layers.

According to one design form, a heterogeneous mixture consisting of a metal powder and a hard material powder is used as spray powder 30, whereby the metal powder exhibits a granule size distribution of −63/+10 μm. With this at least 90% of the granules of the metal powder are smaller than 63 μm, ensuring good melting of the metal granules in the hot gas flow. Determination of granule sizes may for example be made with a Fischer Subsieve Sizer. To avoid liquefaction of the metal granules during acceleration on the surface of doctor blade body 11, a granule size distribution of the metal powder which is as narrow as possible is selected. In the stated granule size distribution 90% of the granules of the metal powder are therefore larger than 10 μm. In an additional design form the granule size distribution of the metal powder is selected even narrower at −48/+18 μm, thereby ensuring that the prevailing plurality of the metal powder granules exhibit approximately the same melting condition when impinging on the surface of the doctor blade base body.

In order to improve the wear resistance of the coating, hard material granules have hitherto been used which, depending on the material, have granule sizes of 2.5 μm or also larger than 3.0 μm.

These granule sizes are preferred since they exhibit strong integration into the metal matrix of the Cermet-coating and due to their size absorb the bulk of the load affecting the coating surface. It has been shown however, that the size of the hard material particles or respectively granules is not crucial for the formation of a wear resistant surface. Rather, the wear resistance of a Cermet-coating is substantially determined by the homogeneity of the distribution of the hard material granules in the metal matrix. Good dispersion properties of the hard material granules in the metal matrix are important for this. It has been shown that hard material powders with a lower medium granule size disperse better in the metal matrix than those with a higher medium granule size. According to one design form at least 90% of the granules of the hard material powder used in the spray powder therefore have sizes smaller than 2.0 μm. In an additional design form the hard material powder also contains a certain portion of very fine powders, whereby only approximately 10% of the hard material powder has sizes smaller than 15 nm, so that no pure metal matrix exists between the larger hard material granules, but rather a metal matrix with a certain base portion of finest hard materials. This additionally increases the hardness of the metal matrix.

In an advantageous design form a hard material powder with a very narrow granule size distribution of −0.8/+0.5 μm is used, based on which a uniform distribution of the hard material granules is achieved in the metal matrix of the Cermet-coating and inhomogeneity in the wear resistance of the coating are avoided.

For effective integration of the hard material particles the metal matrix of the Cermet-coating must have viscous properties. Suitable materials for the formation of the metal powder are for example iron, cobalt, copper, nickel, chromium. Preferred however are hard metal alloys on the basis of these metals, whereby nickel as well as nickel-chromium alloys, cobalt-chromium alloys and nickel-cobalt-chromium alloys are especially preferred. Other materials can also be used for formation of the metal powder; however at least 80% of the metal powder should consist of one or several of the listed materials.

As material for the formation of the hard material powder carbides, nitrides, carbonitrides, borides and ceramic metal oxides can be used. Carbides can be pure carbides or mixed carbides, whereby the use of carbides and mixed carbides of the elements tungsten (W), chromium (Cr), vanadium (V), tantalum (Ta), titanium (Ti), molybdenum (Mo), niobium (Nb) and boron (B) is preferred. According to one design form the carbides used in the hard material powder of the spray powder preferably exhibit a granule size distribution of −1.0/+0.4 μm and especially preferably of −0.8/+0.6 μm. With this, the size of the hard material granules in the Cermet-coating varies only very slightly, based on which the load of the Cermet-coating surface is removed uniformly over the hard material granules embedded therein. When using ceramic metal oxides as material for the formation of the hard material powder, metal oxides are preferred which are formed from the elements: chromium (Cr), aluminum (Al), titanium (Ti), yttrium (Y) and zirconium (Zr), namely in particular Cr₂O₃, Al₂O₃, TiO₂, Y₂O₃ and ZrO₂. A granule size distribution of −2.0 μm/+15 nm and in particular of −0.8/+0.5 μm is preferred for the ceramic metal oxide granules in the hard material powder.

In addition to the good dispersion properties and the uniform distribution of the hard material portion in the Cermet-coating promoted thereby, the granule sizes listed for the hard material powder enable the formation of a smoother coating surface, thereby substantially reducing the expense for finishing related to smoothing of the coating surface. Moreover, the overspray occurring during coating also reduces, so that a more effective use of material is achieved.

The described coating with spray powder as previously discussed is principally used for coating of doctor blade base bodies consisting of spring steel, stainless steel and non-iron alloys, whereby thicknesses of the doctor blade base bodies are typically between 0.25 and 2.00 mm. The thickness of a coating 12 applied with one of the spray powders described above varies depending on the application and can have values of 0.15 to 300 μm. It must however be mentioned that on thin coats granule sizes are preferably used which are no larger, and if possible smaller, than the layer thickness to be produced. With such coat thicknesses the finishing effort related to thinning of the coating is lower than with conventional spray mediums due to the smaller size of the hard material particles in the spray powder.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A spray powder to produce a Cermet coating on a doctor blade surface, said spray powder comprising:
a heterogeneous mixture including one metal powder and one hard material powder, said metal powder including a plurality of granules, said hard material powder including a plurality of granules, at least 90 percent of said plurality of granules of said metal powder having a plurality of sizes of less than 63 μm, at least 90 percent of said plurality of granules of said hard material powder having a plurality of sizes of less than 2 μm.

2. The spray powder according to claim 1, wherein at least 90 percent of said plurality of granules of said metal powder has a plurality of sizes of less than 48 μm.

3. The spray powder according to claim 1, wherein at least 90 percent of said plurality of granules of said metal powder has a plurality of sizes larger than 10 μm.

4. The spray powder according to claim 1, wherein at least 90 percent of said plurality of granules of said metal powder has a plurality of sizes larger than 18 μm.

5. The spray powder according to claim 1, wherein at least 90 percent of said plurality of granules of said hard material powder has a plurality of sizes larger than 15 nm.

6. The spray powder according to claim 1, wherein at least 90 percent of said plurality of granules of said hard material powder has a plurality of sizes larger than 0.5 μm.

7. The spray powder according to claim 1, wherein said metal powder includes at least 80 percent a material which is selected from a group which includes at least one of iron, cobalt, copper, nickel, chromium, an iron alloy, a cobalt alloy, a copper alloy, a nickel alloy, and a chromium alloy.

8. The spray powder according to claim 7, wherein said metal powder includes at least 80 percent a material selected from a group which includes Ni, NiCr, CoCr, and NiCoCr.

9. The spray powder according to claim 1, wherein said hard material powder includes at least 80 percent a material which is selected from a group which includes a plurality of carbides, a plurality of nitrides, a plurality of carbonitrides, a plurality of borides, and a plurality of ceramic metal oxides.

10. The spray powder according to claim 9, wherein said hard material powder includes said plurality of carbides selected from a group which includes carbides and mixed carbides of elements W, Cr, V, Ta, Ti, Mo, Nb, and B.

11. The spray powder according to claim 9, wherein said hard material powder includes said plurality of carbides including a plurality of carbide granules, at least 90 percent of said plurality of carbide granules having a plurality of sizes larger than 0.4 μm, at least 90 percent of said plurality of carbide granules having a plurality of sizes smaller than 1.0 μm.

12. The spray powder according to claim 9, wherein said hard material powder includes said plurality of carbides including a plurality of carbide granules, at least 90 percent of said plurality of carbide granules having a plurality of sizes larger than 0.6 μm, at least 90 percent of said plurality of carbide granules having a plurality of sizes smaller than 0.8 μm.

13. The spray powder according to claim 9, wherein said hard material powder includes said plurality of ceramic metal oxides which are selected from a group which includes ceramic metal oxides of at least one of elements Cr, Al, Ti, Y and Zr.

14. The spray powder according to claims 9, wherein said hard material powder includes said plurality of ceramic metal oxides including a plurality of metal oxide granules, at least 90 percent of said plurality of metal oxide granules having a plurality of sizes larger than 15 nm, at least 90 percent of said plurality of metal oxide granules having a plurality of sizes smaller than 2.0 μm.

15. The spray powder according to claims 9, wherein said hard material powder includes said plurality of ceramic metal oxides including a plurality of metal oxide granules, at least 90 percent of said plurality of metal oxide granules having a plurality of sizes larger than 0.5 μm, at least 90 percent of said plurality of metal oxide granules having a plurality of sizes smaller than 0.8 μm.

16. A doctor blade, said doctor blade comprising:
a Cermet-coating having a thickness which is at least 0.15 μm and 300 μm maximum, said Cermet-coating being produced in a thermal coating process using a spray powder, said spray powder including a heterogeneous mixture including one metal powder and one hard material powder, said metal powder including a plurality of granules, said hard material powder including a plurality of granules, at least 90 percent of said plurality of granules of said metal powder having a plurality of sizes of less than 63 μm, at least 90 percent of said plurality of granules of said hard material powder having a plurality of sizes of less than 2 μm.

17. The doctor blade according to claim 16, wherein said Cermet-coating has a thickness which is at least 1.0 μm and 200 μm maximum.

18. The doctor blade according to claim 16, wherein at least 90 percent of said plurality of granules of said metal powder has a plurality of sizes of less than 48 μm.
